(19) United States
(12) Patent Application Publication
(10) Pub. No.: US 2010/0243730 A1
(43) Pub. Date: Sep. 30, 2010

(54) SYSTEMS AND METHODS RELATING TO MULTI CURRENCY CARD

(75) Inventor: Alan Safahi, Anaheim Hills, CA (US)

Correspondence Address: KNOBBE MARTENS OLSON & BEAR LLP, 2040 MAIN STREET, FOURTEENTH FLOOR, IRVINE, CA, 92614, US

(73) Assignee: WHY WORRY, LLC, Anaheim, CA (US)

(21) Appl. No.: 12/409,819

(22) Filed: Mar. 24, 2009

(51) Int. Cl. G06K 5/00

(52) U.S. Cl. 235/380

(57) ABSTRACT

Systems and methods allow changing a default currency of a multi-currency card. The default currency may be changed by: (1) accessing a database of card numbers associated with currency identifies that indicate the currencies in which payments may be processed for a the multi-currency card to retrieve currency-change rules that apply to the multi-currency card; (2) determining circumstances of how the multi-currency card is to be used; (3) applying the currency-change rules retrieved for the multi-currency card to the determined circumstances; (4) choosing, based on the currency-change rules and the circumstances, a favorable default currency; and (5) changing the default currency of the multi-currency card to the favorable default currency. The default currency defines a currency in which transactions on the card are transacted.

### BACKGROUND

1. Field

The disclosure relates to multi-currency payment systems.

2. Description of the Related Art

Some existing credit and debit cards allow a consumer to make payments abroad. However, credit and debit cards typically have a single default currency and require currency conversion for transactions in a foreign currency. Consumers generally cannot easily change the default currency of a card. Accordingly, consumers may incur high currency conversion costs when they use a credit or debit card outside of their home country.

### SUMMARY

Embodiments of the systems and methods described herein provide a multi-currency card associated with multiple currencies. The systems and methods can periodically change the default currency of the multi-currency card such that consumers can pay for goods or services using a currency that is most favorable to the consumer under the circumstances of a particular transaction or group of transactions. For example, if a consumer will be in Europe during a given month, one embodiment of the system changes the default currency of the multi-currency card to Euros during that month so that the consumer can make payment directly in Euros while in Europe rather than converting from Dollars to Euros. In this embodiment, the system allows the user to specify rules or other relevant information to allow the system to determine which currency is most favorable to the consumer. In the above example, the consumer-provided information includes the consumer's schedule (i.e. that the consumer will be in Europe during a given month).

In one embodiment, the system may change a default currency of a multi-currency card in accordance with the following steps: (1) accessing a database of card information comprising a plurality of card numbers and a plurality of currency identifiers associated with each card number, wherein each currency identifier indicates a currency for in which payments may be processed for a card to retrieve at least one currency-change rule that applies to a multi-currency card, wherein the currency-change rule is configured to decide a favorable default currency for the multi-currency card based at least in part on a circumstance in which the multi-currency card may be used; (2) determining at least one circumstance of how the multi-currency card is to be used; (3) applying the currency-change rule retrieved for the multi-currency card to the determined circumstance; (4) choosing, based on the currency-change rule and the circumstance, a favorable default currency; and (5) changing the default currency of the multi-currency card to the favorable default currency, wherein the default currency defines a currency in which transactions on the card are transacted.

In one embodiment, virtual card numbers are used to complete transactions in foreign currencies. In this embodiment, the following steps may be employed to process a payment: (1) receiving identification information of a multi-currency card having a default currency and having a plurality of virtual card numbers associated with the card, each of the virtual card numbers associated with a currency different from the default currency; (2) choosing, from among the currencies associated with the virtual card numbers, a currency that is more favorable than the default currency for completing a payment transaction; and (3) transmitting the virtual card number associated with the more favorable currency to a payment processor such that the payment processor will process the payment in the currency of the virtual card number rather than the default currency of the card.

In one embodiment, a multi-currency card system comprises a plurality of modules of computer-executable instructions configured to allow changing a default currency of a multi-currency card. The modules may include a preference portal, a currency auto-change process, and a currency association module. The preference portal is configured to receive consumer preferences related to which currency to use for given transactions. The currency auto-change process is configured to determine circumstances under which a multi-currency card is to be used and, based on the circumstances, the consumer preferences, and rules concerning which currency to use for given transactions, to determine a favorable default currency for the multi-currency card. The currency association module is configured to access a database comprising information indicating a plurality of currencies associated with the multi-currency card. In this embodiment, payments using the multi-currency card may be processed in any of the associated currencies and any one of the associated currencies may be determined by the currency auto-change process as the favorable default currency for the multi-currency card.

These embodiments, variations thereof, and other embodiments are described in the Detailed Description section. However, both this Summary section and the Detailed Description section are provided by way of example and not limitation of the invention. A skilled artisan will appreciate in light of this disclosure how to adapt the embodiments described herein to create many additional embodiments. Accordingly, neither this section nor the Detailed Description section limits the invention to only the described embodiments. Rather, the claims define the invention, whether presented originally or in a continuing application.

### BRIEF DESCRIPTION OF THE DRAWINGS

FIG. 1 is a conceptual diagram of a multi-currency card in accordance with one embodiment.

FIG. 2 is a block diagram showing a network-based implementation of one embodiment of a multi-currency card system.

FIG. 3 is a block diagram showing a network-based implementation of another embodiment of a multi-currency card system.

FIG. 4 is a functional block diagram depicting one method of processing a payment using a multi-currency card.

FIG. 5 is a functional block diagram depicting another method of processing a payment using a multi-currency card.

FIG. 6 is a flowchart showing a method of using a multi-currency card for making a payment.

FIG. 7 is a flowchart showing a method of using a multi-currency card for making an anonymous payment.

### DETAILED DESCRIPTION

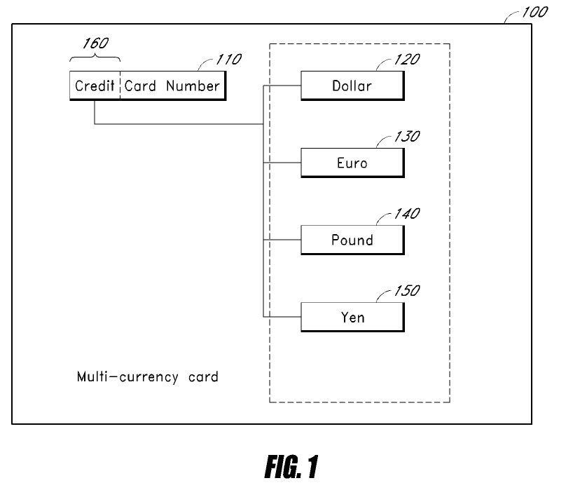

FIG. 1 is a conceptual diagram of a multi-currency card 100 in accordance with one embodiment. The illustrated multi-currency card 100 has a credit card number 110 associated with a number of different foreign currencies. In this figure, those currencies are the Dollar 120, Euro 130, Pound 140, and Yen 150. The multi-currency card 100 may also include or store other data besides the credit card number 110. For example, the card 100 may have an expiration date, a name, an address, other identification or security data, and any other data. The card 100 may display the data, encode the data (such as in a barcode, magnetic strip, or the like), or both.

The illustrated embodiment is associated with four currencies, but the card 100 may be associated with any other number of currencies. In various embodiments, the card 100 is associated with two currencies, three currencies, five currencies, six currencies, seven currencies, eight currencies, nine currencies, ten currencies, or more than ten currencies. One way to associate the currencies with the card 100 is to associate the currencies with a Bank Identification Number (“BIN”) 160 encoded on the card. A BIN 160 has an industry standard format, comprises the first six digits of a card number 110, and identifies the card issuer of a card. As will be appreciated by a skilled artisan, many credit cards have the same BIN.

In one embodiment, each BIN may be associated with a plurality of currencies, such that every card having that BIN is associated with the same currencies. In one embodiment, each BIN is associated with four currencies, but a different number of currencies may be associated. Advantageously, using this method of association, a consumer may choose which currencies he or she wants associated with the card and may then be issued a card with an appropriate BIN that has the chosen currencies associated with the BIN.

Under such a system, a change in the currencies associated with a BIN also changes the currencies for all card numbers having that BIN. In other embodiments, currencies may be associated with individual card numbers such that an individual consumer can change the currencies associated with a card without changing the currencies associated with other cards.

In one embodiment, data identifying the currencies associated with a particular multi-currency card 100 is stored on the card 100 itself Alternatively or additionally, data identifying the currencies may be stored separately from the card 100, such as, for example, in a database. Rather, the multi-currency card 100 may store card identification data. When the card 100 is swiped or entered into an online terminal, the card identification data may be sent over a network. At a network location, a query may be run to determine which currencies are associated with the card.

In another embodiment, the multi-currency card is not even a physical card. The card may be a virtual card. A virtual card retains a credit card number 110 or some other identifying information but would not require the physical, plastic components typically used to read the card at a card terminal. Instead, a virtual multi-currency card user inputs multi-currency card identifying information such as a credit card number 110 into a terminal. Examples of appropriate terminals include: kiosks, telephones, and internet-enabled personal computers. Examples of methods of inputting card information include: speaking, typing or keying, and fingerprint or biometric identification.

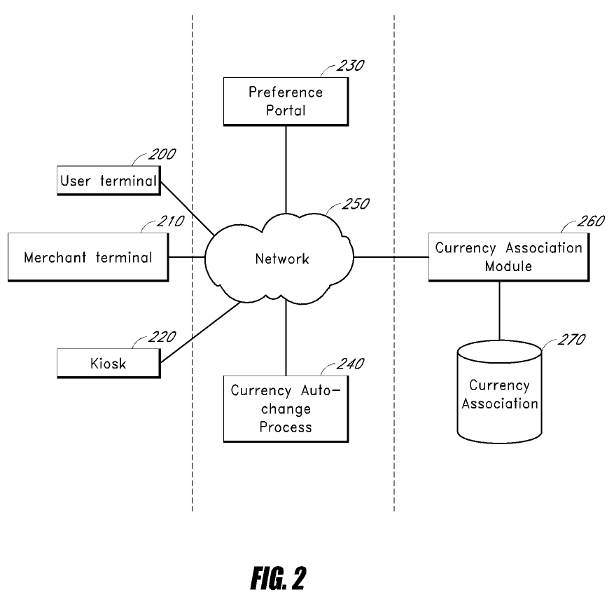

FIG. 2 depicts an embodiment of a multi-currency card system that uses the multi-currency card 100 depicted in FIG. 1. One task that the system in FIG. 2 performs is setting the currency of the multi-currency card 100. The multi-currency card 100 is usable at a user terminal 200, a merchant terminal 210, or a kiosk 220. As already mentioned, the card may be swiped at any of these locations. Alternatively or additionally, card-identifying information may be transferred from the card to a terminal through any method known in the art. These method include, for instance: (1) keying a card number; (2) speaking a card number; (3) scanning a smart chip; (4) reading a magnetic stripe, and (5) scanning a pattern, e.g. a bar code, from the card.

There are a variety of different ways by which the currency of the multi-currency card 100 may be set. Some of these ways require user input; some do not. The method by which the currency is set on the multi-currency card 100 varies depending on user preferences and the capabilities offered by the particular multi-currency card system. Some terminals offer more user choice than others. For instance, a merchant terminal 210 may not allow a user to set the currency of a card at the time of a transaction. This limitation would be advantageous to a merchant, who would not have to buy new card-reading equipment or wait for customers to key in this additional information. However, it may be that the merchant has an agreement with the administrator of the multi-currency card system, in which case the merchant terminal 210 may offer the consumer more expansive control over setting the currency of the card.

FIG. 2 depicts two modules, either one or both of which may be used to set the currency of the multi-currency card 100. The first of the depicted modules is a preference portal 230. The second is the currency auto change process 240. The preference portal 230 and currency auto change process 240 connect to terminals user terminal 200, merchant terminal 210, and kiosk 220 through a network 250.

The preference portal 230 includes, for example, a group of settings or rules governing the currency to which multi-currency card 100 should be set for a given transaction or set of transactions. These settings may be set either by the user, a card company, an algorithm, a set of rules or some other entity associated with the multi-currency card system. In one embodiment, the rules are configured to determine which currency is most advantageous to the consumer for a particular transaction. For example, the rules may take into account the cost of a good or service being purchased, exchange rates, currency conversion fees, and any other transaction fees, to determine which currency results in the lowest cost to the consumer. Alternatively or additionally, the rules may take into account user preferences.

As an example of an interaction involving preference portal 230, a card user begins by swiping a multi-currency card 100 at a merchant terminal 210. The card information is passed through network 250 to the preference portal 230. Preference portal 230 applies the appropriate set of rules to determine a currency to which multi-currency card 100 is set. This currency is forwarded through network 250 to a currency association module 260, which stores the association between the multi-currency card and currency preference in a currency association database 270.

Alternatively, the preference portal 230 does not forward currency-setting data to a currency association module 260, but back to multi-currency card 100, where it is stored on the card itself This alternative embodiment may be a default setting. It may also be implemented as an alternative setting, if for instance the network 250 connection between preference portal 230 and currency association module 260 has been compromised. Alternatively, currency-setting data may be stored on multi-currency card 100 as a redundancy. An example of a technology that enables currency-setting data to be stored back onto a card is smart chip technology. This alternative embodiment is advantageous when travelling abroad, where network connectivity may be spotty and a currency association database 270 inaccessible during a transaction.

An example of a rule that preference portal 230 might apply is a rule stating that a multi-currency card should be set to a specific currency during a certain range of dates. One way of setting a date range using preference portal 230 and the system depicted in FIG. 2 is to input currency card identification information at user terminal 200. For instance, if user terminal 200 is a home PC with an internet connection, a multi-currency card user inputs card identification information into user terminal 200 with a keyboard. Often, this information includes security information, like a billing address or a security code displayed on one side of the card. User terminal 200 directs the multi-currency card information through network 250 to preference portal 230. The preference portal 230 then presents the card user with a selection of options to customize their multi-currency card 100. Among these options is the option to set multi-currency card 100 to a particular currency for a given range of dates. This option is useful to users who know that they will be abroad during some range of dates in the future. Thus, the user can assure that the card will be set to the currency of his travel destination and that his transactions during that time period will be settled in the currency of the country where he is located. Examples of other rules available through the preference portal 230 include: (1) setting a default currency for the card; (2) setting a default currency for transactions that take place in a particular geographic location; or (3) setting a currency selection that triggers at a particular currency exchange rate.

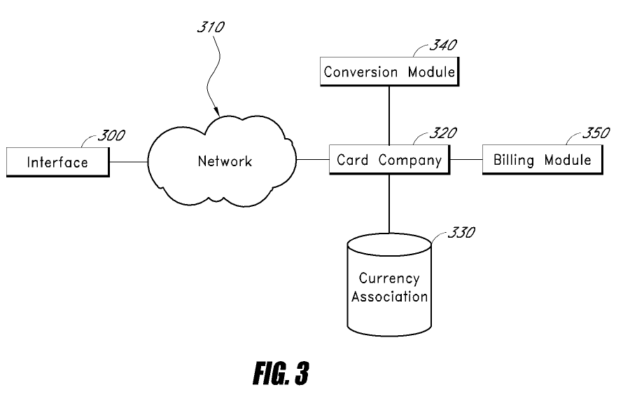

The date-range rule that the user inputs at user terminal 200, with the aid of preference portal 230, is then transferred through network 250 to the currency association module 260 and its currency association database 270 where it is stored for future use. The currency association database 270 is available, then, to a card company as shown in FIG. 3, or merchant terminal 210 to determine the card's currency setting during a transaction.

In addition to illustrating a system by which a multi-currency card may be set, FIG. 2 also illustrates a system through which currency card information may be retrieved. For instance, when a user travels abroad and swipes multi-currency card 100 at a merchant terminal 210, the terminal retrieves currency-setting information either through preference portal 230 according to a preset rule, currency association module 260, or as will be explained, an auto-change process 240.

A wide variety of different types of terminals may be used to access and change multi-currency card information. FIG. 2 depicts one such alternative with kiosk 220. An example of kiosk 220 is an airport kiosk. In the airport kiosk example, a traveler using a multi-currency card 100 visits the kiosk 220 on arrival at his destination to ensure that multi-currency card 100 is set to the currency of that country. This setting allows transactions the user makes in that country to be settled in the currency of that country. Alternatively, the kiosk 220 is an automatic teller machine (ATM) or terminal at a bank branch.

In one embodiment of a kiosk in an airport, the kiosk includes a function for changing the currency of a multi-currency card simply by scanning the card into the kiosk. For example, a traveler may arrive at an airport in a foreign country and swipe the card into the kiosk. The kiosk would read the identification information from the multi-currency card, communicate with one or more databases that store the currency associations of the multi-currency card, and cause the default currency of the card to be changed to the local currency. Thus, an airport kiosk within Europe may be configured to change a multi-currency cards' default currency to the Euro, while an airport kiosk in Japan may be configured to change a multi-currency cards' default currency to Yen. Thus, an airport kiosk may advantageously allow a consumer to change the default currency of his or her card to whatever currency is the local currency of the place where the kiosk is located, without having to make an automatic selection. Alternatively or additionally, an airport kiosk may automate much of the process of changing the cards' currency, but may include certain manual steps, such as, for example, requiring the user to confirm that he or she intends to change the default currency.

We have used the example of an airport as a place where people from foreign countries are often located and may want to change the default currency of a multi-currency card. A skilled artisan will appreciate, in light of this disclosure, that the concept of an “airport kiosk” may in fact be advantageously employed in any location that caters to international travelers, including, for example, train stations, bus stations, hotels or convention centers that host international events, tourist locations that attract international visitors, and the like. Thus, our use of the term “airport kiosk” is by way of example only and does not limit the locations at which such a kiosk may be used.

In addition, while we have used certain terms such as “swiped” or “entered” or “scanned” or the like to describe the process of retrieving information from the card, any method of retrieving information from the card may be used, including, for example, optical reading of a bar code or other optical code, reception of an RFID transmission, reading of a magnetic code, manual data entry of a number or other code, or the like.

The system of FIG. 2 also includes a currency auto-change process 240. The auto-change process 240 uses data from one of the user terminal 200, merchant terminal 210, or kiosk 220, the multi-currency card 100, or other pertinent data to make a decision about which currency the multi-currency card should be set to. In a simple embodiment, the currency auto change process sets the currency of the card to the currency of the location of the transaction or to the currency in which the transaction is being made. A more complex algorithm may be necessary if, for instance, the multi-currency card is limited to a basket of currencies and the transaction is not conducted in one of the available currencies. In this example, the currency auto-change process 240 determines which currency out of the basket of currencies gives the most favorable exchange rate. Although the currency auto-change process may work in conjunction with preference portal 230, it does not require any user input. Like preference portal 230, it helps determine the currency to which multi-currency card 100 should be set.

Advantageously, by changing the default currency of a multi-currency card, a consumer may be able to conduct transactions in foreign currencies while avoiding currency conversion fees typically charged by credit card companies. For example, a consumer traveling in Europe may change his or her default currency to Euros and conduct transactions directly in Euros rather than having the default currency set to Dollars and paying conversion fees for converting Dollars to Euros. Advantageously, the operator of the system described herein may profit in several ways. For example, an operator of the system may be a credit card company who offers a multi-currency card without charging any special fees. While such an operator does not make money from each transaction, the operator may have more open credit card accounts earning interest for the company because frequent international travelers may stop using cards that do not have the multi-currency feature and thus require currency conversion fees. Alternatively, an operator of the system may charge a membership fee, such as, for example, an annual fee. Alternatively or additionally, an operator of the system may charge a transaction fee for changing the currency of the card. Thus, for example, when a user changes the card's currency at an airport kiosk, the operator of the kiosk may charge a fee. Alternatively or additionally, an operator of the system may charge a fee for each foreign transaction. Such a fee may be a flat fee or a percentage fee based on the amount of a sale. A skilled artisan will appreciate that a percentage-based transaction fee is much like a currency conversion fee. Accordingly, an operator who charges a percentage-based transaction fee will generally want to charge a lower percentage fee than the consumer would pay for currency conversion using a standard credit card.

FIG. 3 depicts what can be used an alternative or a supplemental multi-currency card system to the one depicted in FIG. 2. The FIG. 3 system includes an interface 300 that gathers multi-currency card information and transmits it over network 310 to card company 320. As mentioned earlier, the multi-currency card information includes, for example, card identification information and transaction information. As one aspect of the embodiment of FIG. 3, the card company 320 decides the most favorable currency to which multi-currency card 100 should be set.

In another aspect, card company 320 utilizes a currency association database 330 that has been set through an system like that depicted in FIG. 2 (or, indeed, FIG. 3). In this case, the card company 320 queries currency association database 330 to find out which currency the card is set to—and therefore, which currency the transaction ought to be settled in. This currency setting may be made in any of the ways already described in reference to FIG. 2.

Once card company 320 has retrieved the currency setting for multi-currency card 100 from the currency association database 330, it settles the transaction in the currency to which the card is set. After settling the transaction, card company 320 queries a conversion module 340 to convert the currency settlement type into the currency used to bill the customer. For instance, card company 320 queries a conversion module 340 to convert the currency in which the transaction has been settled to dollars, in which the user will be billed. Card company 320 then links to billing module 350 to bill the user in the user's currency. Billing module 350 bills the user in any of the ways well known in the industry.

Among other reasons, the multi-currency card system depicted in FIG. 3 is advantageous because it has access to currency association database 330. Currency association database 330 stores multi-currency card information, allowing the multi-currency card transaction to be settled in merchant's currency. While currency association database 330 is depicted linked to card company 320 in FIG. 3, one of skill in the art will recognize that database 330 may alternatively be linked through network 310 to any number of entities within a multi-currency card system. Thus, the currency conversion operation is not limited to a merchant or credit card company—either of which will often charge high fees to convert currency or for transactions that occur abroad. Instead, the system of FIG. 3 enables the third party processors, resellers, and other entities through which card transactions are processed to make the necessary conversion between the transaction currency and billing currency. This flexibility derives, among other reasons described in this disclosure, from the ability to settle a transaction in the currency of the merchant. Thus, it will be understood that card company 320 need not refer to one of the more commonly card companies like Mastercard or Visa but may in fact refer to any party dealing with multi-currency card transactions in a multi-currency card system.

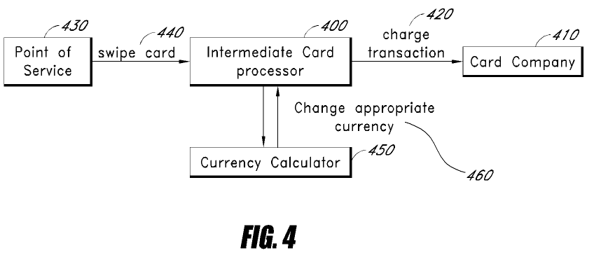

The advantages of the multi-currency card system are shown again in the system diagram of FIG. 4, which depicts an intermediate card processor 400. This intermediate card processor 400 may in fact be an instance of a card company 320 as depicted in FIG. 3. However, in FIG. 4, it has been made separate from another card company 410 to which the transaction is eventually charged. This transaction is charge transaction line 420.

In FIG. 4, the transaction is initiated at a point of service 430. A card user swipes the card along swipe card line 440. The swiped card information is then passed along through intermediate card processor 400. The intermediate card processor 440 does a change-currency operation 460 that utilizes currency calculator 450. Once intermediate card processor 400 has used this change-currency operation 460, it charges transaction 420 to the card company 410.

In FIG. 4, the intermediate card processor 400 examines the characteristics of a transaction. Data related to the transaction is received from swipe-card operation 440. The intermediate card processor 400 changes the currency of the multi-currency card and charges the transaction 420 to the card company 410. The intermediate card processor 400 uses currency calculator 450 to find the appropriate currency in which to charge the transaction.

In one aspect of the multi-currency card system depicted in FIG. 4, the multi-currency card and card company 410 use a card's BIN to determine which currencies are associated with a card, as described earlier. In one embodiment, each BIN may be associated with four currencies, such that each card having that BIN may use any one of the four currencies. If the card user tries to charge a transaction with a merchant in a currency not selected from one of those four currencies, intermediate card processor 400 uses currency calculator 450 to find the most favorable currency in which to settle the transaction. In change-currency operation 460, intermediate card processor 400 changes the multi-currency card 100 to the most favorable currency associated with the BIN and thus available to the user of the card. In charge-transaction operation 420, the intermediate card processor 400 sends data concerning not only the amount and location of the transaction, but also the selected currency to which the multi-currency card should be changed. Card company 410 settles the transaction in that favorable currency.

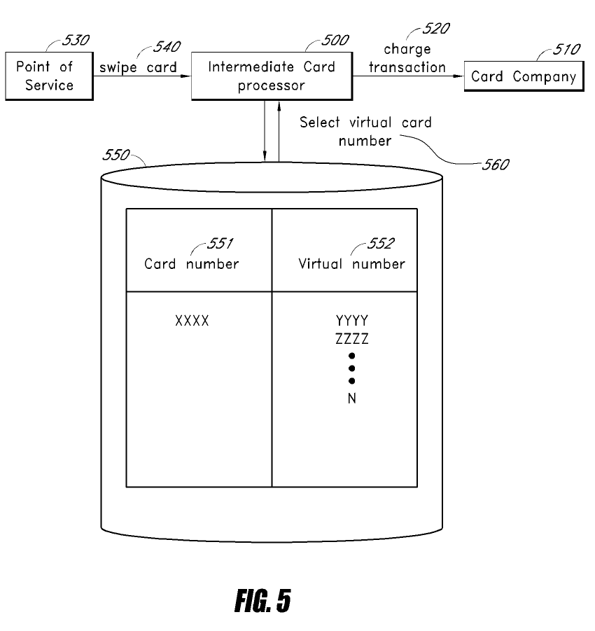

FIG. 5 depicts a variation on the multi-currency card and multi-currency card systems depicted in FIGS. 1-4. As noted in relation to those figures, an embodiment of multi-currency card 100 is a card associated with a plurality of different foreign currencies. Although the association between card 100 and a plurality of currencies may be set and stored at a number of different points within the multi-currency card system—examples given included a card company, intermediate card processor, merchant, or user terminal—it remains the case in these embodiments that a card's currency changes. These embodiments therefore have an advantageous simplicity. However, it may not always be desirable as a matter of design choice, limitations in legacy systems, or pressures from market forces to implement a multi-currency card system in which multi-currency card 100 is associated with a different currency depending on circumstances. While the systems in FIG. 1-4 are adaptable to different embodiments, the system in FIG. 5 more clearly depicts an alternative system.

Instead of changing a currency setting for multi-currency card 100, the system of FIG. 5 associates multi-currency card 100 with a virtual card in foreign currency.

Some aspects of the system are very similar to the components depicted in FIG. 4. Multi-currency card 100 is swiped at a point of service 530. Swipe-card operation 540 sends information to an intermediate card processor 500, which in turn charges the transaction 520 to a card company 510. Unlike the charge-transaction 420 example described in relation to FIG. 4, the charge-transaction operation 520 from FIG. 5 does not send card currency setting information along with the other transaction data. Instead, intermediate card processor 500 selects 560 a virtual card that is already set to the appropriate currency and charges 520 the transaction to this virtual card.

The select-virtual-card-number operation 560 allows an intermediate card processor 500 to query a database of virtual numbers 550. The database of virtual numbers 550 contains a table that associates the card number 551 of a multi-currency card 100 with a series of virtual numbers 552. Each of these virtual card numbers corresponds to a virtual card in a particular currency. As an example, virtual card number YYYY is a virtual card in dollars and ZZZZ is a virtual card in euros. Instead of selecting a currency to which the multi-currency card 100 should be set, intermediate card processor 500 selects a virtual card number 552 from the database 550 corresponding to the desired or favorable currency. The intermediate card processor 500 charges transaction 520 not to the multi-currency card number 551, but rather to the virtual card number 552 that corresponds to a currency favorable to the transaction taking place at point of service 530.

There are a number of ways in which to associate virtual card numbers 552 with a multi-currency card number 551. One simple embodiment is to associate multi-currency card number 551 with a plurality of virtual card numbers 552, each of which virtual card numbers 552 corresponds to a single currency and a single multi-currency card number 100. This embodiment has an advantageous simplicity and requires little transactional processing. However, it may also require a larger number of resources to open new foreign card account numbers 552 for each multi-currency card number 551 that is created. In light of these considerations, this embodiment may be most advantageous for travelers who frequent a handful of countries and need only create virtual card accounts for the currencies of those particular countries.

An alternative to the one-to-one association just described is a basket of virtual card numbers 552, each of which is used for more than one multi-currency card number 551. In this embodiment, intermediate card processor 500 keeps track of each transaction charged to a virtual card number 552 to ensure that it is ultimately billed to the correct user of each multi-currency card. Although this entails transactional overhead to track transactions by each user of a multi-currency card 100, the system requires only a handful of virtual card numbers—as few as one per type of currency—depending on the account limits for each virtual card number. A hybrid system is also possible, in which a shared virtual card number is used for uncommonly used currencies, but unique virtual card numbers are assigned to the multi-currency card for more heavily used currencies. A user may be charged extra to set up a multi-currency card 100 with more, unique virtual card numbers associated with it.

There are several advantages to the virtual card embodiment of the multi-currency card system. As noted earlier, it may require few or no changes to the billing system of the billing card company 510. This is because the card company 510 sees as part of the charge transaction 520 step only the virtual card number 552. Virtual card number 552 is already set to the currency in which the transaction is to be charged.

Another potential advantage to a virtual card system is the ability for multi-currency card users 100 to purchase goods or services from foreign companies or foreign sites. Many internet companies do not let consumer purchase goods from a foreign website unless they have a foreign credit card associated with a billing address in that foreign country. In one embodiment, a virtual card number 552 is associated with foreign address. For example, the foreign address is the business address of a foreign branch office of intermediate card processor 500. In this example, a multi-currency card user charges a transaction to a merchant. The merchant verifies the transaction through the foreign address associated with a virtual card number 552.

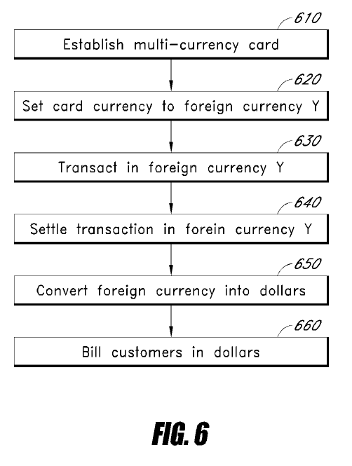

FIG. 6 depicts a method of using a multi-currency card system. First, a multi-currency card is established 210. This may be performed through an application process in which the user fills out an application form. Or, a card issuer can set up a multi-currency card 100 by default, without input from an applicant. Once a multi-currency card has been established 210, the card is set 220 to foreign currency Y. For instance, the card user sets 220 a multi-currency card 100 to Euros at an airport kiosk like the one depicted in FIG. 2. The breadth of different criteria, methods, and actors through which a card currency is set has already been described in some detail. Once the card currency has been set 620 to a foreign currency Y, the card user may transact 630 in foreign currency Y. The set foreign currency step 620 and transaction step 630 need not occur in the order depicted in FIG. 6. This will be the case, for instance, where a currency-auto-change process 240 like the one depicted in FIG. 2 sets the card currency based on the characteristics of the transaction. In this case, the transaction must at least be initiated before the card currency is set.

Because the card currency has been set to foreign currency Y in which the transaction is made, the transaction is then settled 240 in the same foreign currency Y. After the transaction is settled, the foreign currency is converted 250 into dollars. This conversion step is performed such that the customer may be billed 260 in dollars or their currency of choice.

The capability to settle a transaction in the foreign currency in which the transaction is made derives from the ability to set 220 a card currency. These abilities are also related to the ability to move the conversion step 250 to the party best able under market conditions to set the best conversion rate. For example, a transaction billed to a virtual card number 552 in a foreign currency reaches the card company without a conversion operation ever needing to occur. The conversion can be made by a third party processor that the card company uses to bill the customer.

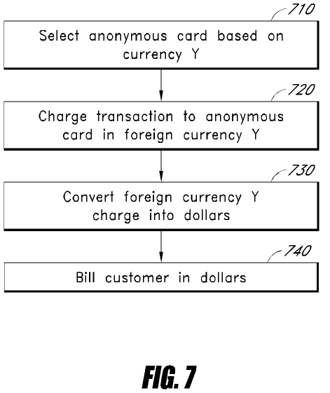

FIG. 7 depicts an alternative method of utilizing a multi-currency card system. The method depicted in FIG. 7 is related to the system depicted in FIG. 5, which uses a table to identify a card number 551 to a virtual card number 552. In one example, an intermediate card processor 500 selects 710 an anonymous card based on currency Y. The transaction is charged 720 to the anonymous card in foreign currency Y, then converted 730 from foreign currency Y into dollars. The customer is billed 740 in dollars.

As with FIG. 6, it will be appreciated that the conversion 730 step depicted in FIG. 7 has been freed from any particular actor in a multi-currency card system, because of the use of anonymous cards in a foreign currency Y. Unlike the method in FIG. 6, a currency is not selected for multi-currency card 100 in the method of FIG. 7. Rather, an anonymous card is selected for its currency setting, and a transaction made with the anonymous card is associated with the user's multi-currency card 100 for later billing.

The foregoing scenario is just one way that the embodiments described herein can be used and is not a limitation on the invention. It is presented only to provide one concrete example of a scenario in which the embodiments described above can be used. A skilled artisan will appreciate, in light of this disclosure, many other ways to use the embodiments described above and other embodiments that would be apparent to a skilled artisan.

The above embodiments have been described by way of example and not limitation. A skilled artisan will appreciate, in light of this disclosure, that while certain advantageous characteristics and features of the systems and methods have been described, that not every characteristic or feature is required for every embodiment. Rather, a skilled artisan will appreciate, in light of this disclosure, that the characteristics and features may be omitted, combined with each other and with other characteristics and features not described herein to implement other alternative embodiments not explicitly described herein. All such embodiments, whether explicitly described herein or that would be apparent to a skilled artisan in light of this disclosure, may be within the scope of the invention. As such, the invention is described by the claims and is not limited to the embodiments set forth above.

What is claimed is:

1. A method of changing a default currency of a multi-currency card, the method comprising:
accessing a database of card information comprising a plurality of card numbers and a plurality of currency identifiers associated with each card number, wherein each currency identifier indicates a currency for in which payments may be processed for a card to retrieve at least one currency-change rule that applies to a multi-currency card, wherein the currency-change rule is configured to decide a favorable default currency for the multi-currency card based at least in part on a circumstance in which the multi-currency card may be used;
determining at least one circumstance of how the multi-currency card is to be used;
applying the currency-change rule retrieved for the multi-currency card to the determined circumstance;
choosing, based on the currency-change rule and the circumstance, a favorable default currency; and
changing the default currency of the multi-currency card to the favorable default currency, wherein the default currency defines a currency in which transactions on the card are transacted.

2. The method of claim 1, wherein the circumstance of use relates to a geographical location that the card is used in.

3. The method of claim 1, wherein a card user at least partially defines the currency-change rule.

4. The method of claim 1, wherein said favorable currency is selected from a plurality of currencies that are associated with a BIN of the card.

5. A method of processing a payment transaction in a currency different from a financial card's default currency, the method comprising:
receiving identification information of a multi-currency card having a default currency and having a plurality of virtual card numbers associated with the card, each of the virtual card numbers associated with a currency different from the default currency;
choosing, from among the currencies associated with the virtual card numbers, a currency that is more favorable than the default currency for completing a payment transaction; and
transmitting the virtual card number associated with the more favorable currency to a payment processor such that the payment processor will process the payment in the currency of the virtual card number rather than the default currency of the card.

6. A multi-currency card system comprising a plurality of modules of computer-executable instructions configured to allow changing a default currency of a multi-currency card, the plurality of modules including at least:
a preference portal configured to receive consumer preferences related to which currency to use for given transactions;
a currency auto-change process configured to determine circumstances under which a multi-currency card is to be used and, based on the circumstances, the consumer preferences, and rules concerning which currency to use for given transactions, to determine a favorable default currency for the multi-currency card; and
a currency association module configured to access a database comprising information indicating a plurality of currencies associated with the multi-currency card, wherein payments using the multi-currency card may be processed in any of the associated currencies and wherein any one of the associated currencies may be determined by the currency auto-change process as the favorable default currency for the multi-currency card.
